(19) United States
(12) Patent Application Publication
(10) Pub. No.: US 2007/0104889 A1
(43) Pub. Date: May 10, 2007

(54) Apparatus and method for the surface treatment of workpieces

(75) Inventors: Wieland Flothmann, Moetzingen (DE); Roger Schmidt, Holzgerlingen (DE)

Correspondence Address: FACTOR & LAKE, LTD, 1327 W. WASHINGTON BLVD., SUITE 5G/H, CHICAGO, IL, 60607, US

(73) Assignee: Eisenmann Maschinenbau GmbH & Co. KG

(21) Appl. No.: 11/593,332

(22) Filed: Nov. 6, 2006

(30) Foreign Application Priority Data
Nov. 7, 2005 (DE) 10 2005 053 327.2

(51) Int. Cl. B05D 3/02; B05C 13/00

(52) U.S. Cl. 427/541; 427/553; 427/374.1; 118/66; 118/58; 118/400

(57) ABSTRACT

An apparatus and a method for the surface treatment of workpieces, in particular for the wet chemical pretreatment of workpieces to be painted, are described. The apparatus comprises at least one pretreatment zone operating with a water-containing treatment liquid and at least one drying device for drying treatment liquid adhering to the surfaces of the workpieces. In order to dry the treatment liquid quickly and with a high energy efficiency, the drying device comprises at least one microwave generator with which the treatment liquid is dried.

### RELATED APPLICATIONS

The present invention claims the benefit of the filing date of German Patent Application, Serial No. 10 2005 053 327.2, filed Nov. 7, 2005; the content of which is incorporated by reference herein.

### TECHNICAL FIELD

The present invention relates to an apparatus for the surface treatment of workpieces, in particular for the wet chemical pretreatment of workpieces that are subsequently to be painted, with at least one pretreatment zone operating with a water-containing treatment liquid and at least with a drying device for drying water-containing treatment liquid adhering to the surfaces of the workpieces.

The invention also relates to a method for the surface treatment of workpieces, in particular for the wet chemical pretreatment of workpieces that are subsequently to be painted, in which the surfaces of the workpieces are subjected to a treatment with a water-containing treatment liquid and treatment liquid adhering to the surfaces of the workpieces is dried.

### BACKGROUND OF THE INVENTION

Known apparatuses and methods of the type mentioned in the introduction are used for example to pretreat workpieces, in particular automotive construction parts, in chemical baths or rinsing units with in particular grease removers and/or surfactants for a subsequent painting. In order to ensure a good adhesion of the paint by avoiding surface defects caused by adhering water residues and also the formation of bubbles, treatment liquid, in particular water in droplet form, adhering to the surfaces of the workpieces must be removed. This is achieved by drying with special drying devices.

It is known to use circulating air dryers, for example convection dryers, for this purpose, in which the workpieces are dried with a jet of generally very hot air in a drying cabinet and the moist warm waste air is then extracted from the drying cabinet. When drying plastics materials the drying temperature must not exceed 90° to 100° C. since these materials would otherwise become unstable.

Other known drying devices use condensation dryers, with which the surfaces of the workpieces are dried in a time-consuming and energy-intensive manner.

It is also known to dry water-based paints on plastics surfaces using microwaves. In order to achieve a high paint quality a uniform drying of the overall paint coat that is formed on the surface of the workpiece is necessary. Using microwaves the paint coat is then dried in a self-regulating and complete manner over the whole coat surface. In order to avoid the formation of bubbles and/or chemical reactions in the paint layer, the self-regulating process must be controlled through the water content and the optimised adsorbtion properties of the water-based paint. The demands regarding the drying of water-based paints are therefore completely different to those concerning the drying of adhering water on surfaces of the workpieces. The adhering water adheres in fact in the form of individual, for the most part non-coherent, droplets on the surfaces of the workpieces. When drying adhering water, heating over the whole surface is therefore not at all required. Instead, ideally only the droplets should be locally heated and evaporated in order to achieve a rapid drying with a high energy efficiency. Also, the adsorbtion properties of the workpiece surfaces do not play any part in the drying of adhering water. Completely different and indeed even contrary requirements are therefore demanded of the drying device, which means that known microwave dryers, such as are used for drying water-based paints, have up to now not been considered at all for drying adhering water on surfaces of workpieces.

The present invention is directed to resolving these and other matters.

### SUMMARY OF THE INVENTION

The object of the present invention is to provide an arrangement of the type mentioned in the introduction in which a conveyance and a rotation of the workpieces can be realised in a technically simple and reliable manner.

The object of the present invention is accordingly to provide an apparatus and a method of the type described in the introduction so that in particular individual droplets of a water-containing treatment liquid, in particular water, on the surface of the workpieces can be dried in a technically simple and rapid manner and with a high energy efficiency.

This object is achieved according to the invention in that the drying device comprises at least one microwave generator for drying the water-containing treatment liquid.

According to the invention microwaves are thus generated with at least one microwave generator, in particular a magnetron, with which in particular droplets of water-containing treatment liquid adhering to the surfaces of the workpieces can be directly heated and evaporated. Thus, depressions, for example pits, and capillary regions, for example perforations, in the surfaces of the workpieces can be dried without the workpieces themselves having to be unnecessarily strongly heated. The workpieces may in this way be dried very efficiently, so that an entrainment of the treatment liquid for example into a following paint zone is avoided and also no post-treatment of the surfaces is necessary in order to remove droplets of a treatment liquid. Also, there is virtually no heat transfer from the treatment liquid to the workpiece surfaces, since the water evaporates very rapidly. The slight heating of the workpieces has the great advantage that these are carefully treated, so that the apparatus can also be used with sensitive workpieces, for example of plastics materials. Since the individual small volume water droplets are locally heated and evaporated, a greater energy efficiency and a significantly more rapid drying is possible than with the circulating air dryers or condensation dryers known from the prior art, in which the air surrounding the workpiece and in certain cases even the conveying equipment and the workpiece carriers are also heated. In this way any downstream cooling zone also requires a smaller cooling output, so that here too there is an additional saving in energy. Depending on the workpiece geometry a cooling zone may even be dispensed with. Overall the drying of adhering water on the surfaces of the workpieces using microwaves achieves a very high efficiency compared with conventional dryers and leads to significantly shorter drying times and thus to a significant reduction in operating costs, in particular with regard to gas and power consumption. If the drying time in a conventional dryer is about 20 to 25 minutes, then in the microwave dryer according to the invention it can be reduced to about 3 to 4 minutes. In addition, the microwave generator requires much less installation space than for example a hot air fan of a conventional circulating air dryer. Moreover the maintenance expenditure is significantly less since the microwave generator has no movable parts and therefore is also subject to less wear and tear.

The workpieces may be appropriately pretreated in the pretreatment zone of the apparatus, in particular degreased, cleaned and rinsed with water-containing treatment liquid, and then dried, without the workpieces having to be removed from the apparatus. The transportation of the workpieces through the zones may be effected in a pulsed, continuous or reversible manner. All known types of material transportation on workpiece carriers are possible.

The workpieces may be of plastics materials or metal. On workpieces of certain plastics materials, the microwaves have the positive side effect that for example their outgassing for the preparation for the subsequent painting procedure can be improved.

In order for the microwaves to be able to penetrate uniformly the surroundings of the surfaces of the workpieces, so that the adhering treatment liquid is exposed to the undamped microwaves, the drying device may comprise a plurality of microwave generators, in particular magnetrons, arranged in particular annularly around a conveying pathway of the workpieces.

In addition the conveying pathway upstream of the microwave zone may lead through a blowing zone and/or, connected to the microwave zone, through a cooling zone. Most of the treatment liquid can be removed from the surface of the workpieces by blowing in the blowing zone, so that following this only individual droplets of treatment liquid still remain on the surface and can be heated and evaporated quickly and with little energy expenditure with microwaves in the microwave zone. The workpieces can be cooled in the following cooling zone, so that they can then be passed directly to a painting zone for painting.

The method according to the invention is characterised in that the treatment liquid is dried with microwaves. Treatment liquid adhering to the surfaces of the workpieces is heated and evaporated quickly and with a high energy efficiency with microwaves. At the same time depressions and capillary regions are also thereby dried without the workpieces themselves having to be heated.

The workpieces may in this way be cleaned, rinsed with the treatment liquid, and then directly dried. The treatment liquid, in particular water, is in this connection removed without leaving any residue, so that no post-treatment of the surface is necessary.

The treatment liquid may be blown off from the surfaces of the workpieces before treatment liquid still adhering to the surfaces is dried with microwaves, and/or the workpieces can be cooled after treatment liquid still adhering thereto has been dried with microwaves. Due to the fact that most of the treatment liquid is blown off before the drying stage with microwaves, the drying procedure is significantly accelerated and moreover energy is saved. The cooling of the workpieces following the microwave drying has the great advantage that the workpieces can then be painted directly without long cooling times or even without any cooling times at all.

### BRIEF DESCRIPTION OF THE DRAWINGS

Embodiments of the invention are described in more detail hereinafter with the aid of the drawings, in which:

FIG. 1 shows diagrammatically a plan view of a pretreatment apparatus for the wet chemical pretreatment of workpiece surfaces;

FIG. 2 shows diagrammatically in detail a plan view of a microwave zone of the pretreatment apparatus of FIG. 1; and,

FIG. 3 shows diagrammatically an isometric detailed view of the microwave zone of FIG. 2 in the region of a magnetron ring.

### DETAILED DESCRIPTION OF THE PRESENT INVENTION

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

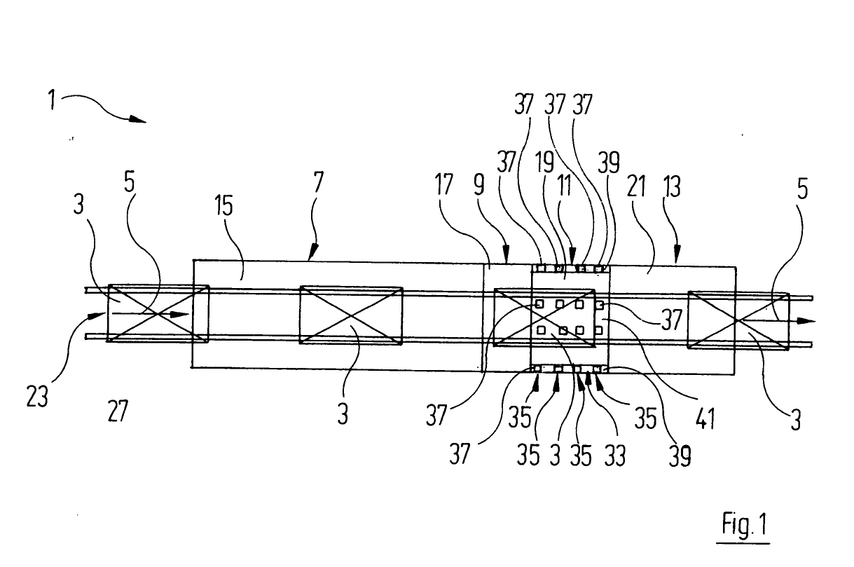

FIG. 1 is a plan view of a pretreatment apparatus identified overall by the reference numeral 1 for the wet chemical pretreatment of surfaces of workpieces 3 of plastics materials that are subsequently to be painted.

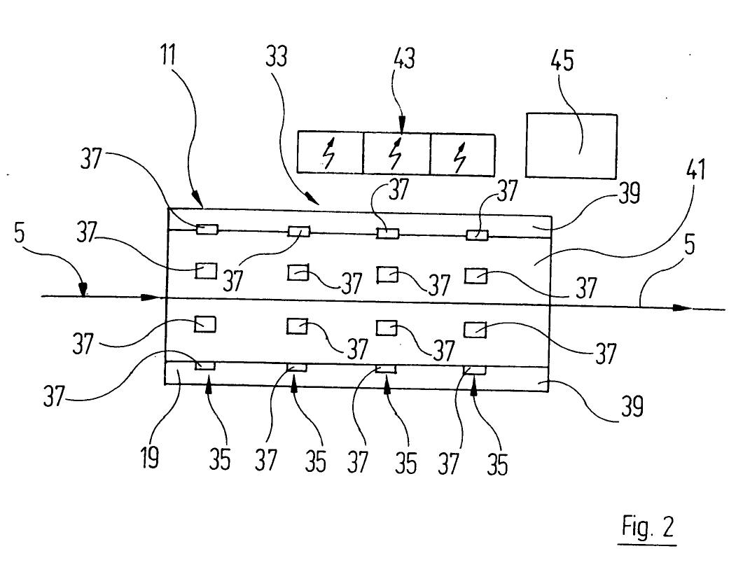

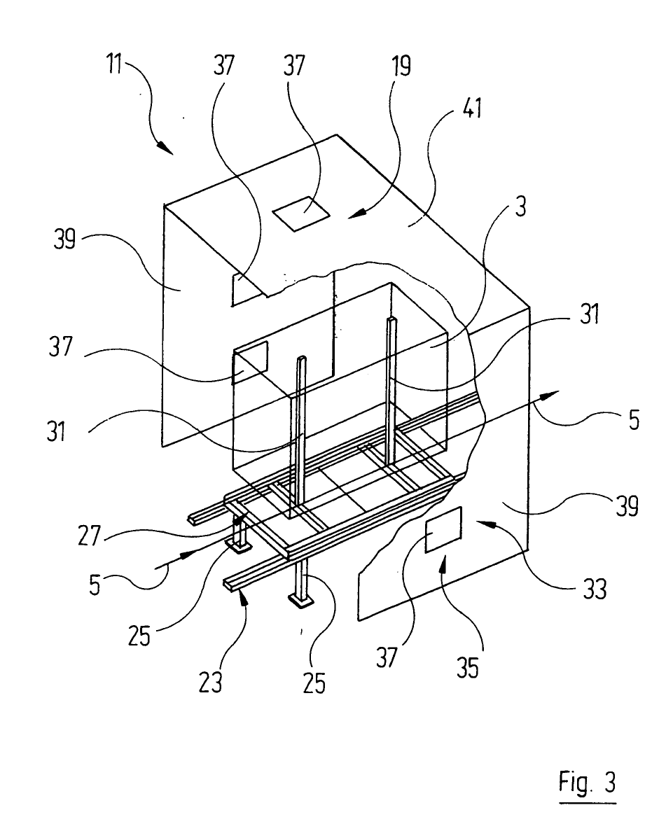

The pretreatment apparatus 1 comprises along a conveying pathway identified by the arrows 5, which in FIGS. 1, 2 and 3 runs substantially horizontally from left to right, in sequence a wet chemical pretreatment zone 7, a blowing zone 9, a microwave zone 11 also shown in detail in FIGS. 2 and 3, and a cooling zone 13. The zones 7, 9, 11 and 13 are in each case surrounded respectively by a cube-shaped cabin 15, 17, 19 and 21, which may be open to the respective adjacent zone 7, 9, 11 and 13. The cabin 17 of the wet chemical pretreatment zone 7 in the feed direction for the workpieces 3, in the left-hand side of FIG. 1, and the cabin 21 of the cooling zone 13 in the exit direction, in the right-hand side of FIG. 1, can be open externally to the surroundings or can be accessible via an air lock.

A straight conveying system 23 comprising two parallel guide tracks runs from the left along the conveying pathway 5 on the cabin floor on supports 25, visible in FIG. 3, into the cabin 15 of the wet chemical pretreatment zone 7, through this cabin and through the cabins 17 and 19 respectively of the following blowing zone 9 and microwave zone 11, and exits at the right from the cabin 21 of the cooling zone 13. Known rectangular skids 25 with workpiece carriers 31, visible in FIG. 3, on which the workpieces 3 are arranged, can be conveyed on the conveying system 23 along the conveying pathway 5 through all the zones 7, 9, 11 and 13. FIG. 3 shows in detail a section of the microwave zone 3 through which the conveying system 23 runs, on which is directly arranged a skid 25, similar to those of FIG. 1, with two vertical workpiece carriers 31 manufactured from profiled sections, on which a cube-shaped workpiece 3 is mounted.

Chemical baths, not shown in detail, containing grease removers and surfactants, in which the workpieces 3 can be cleaned and pretreated, are arranged in the wet chemical pretreatment zone 7. Rinsing devices, likewise not shown in detail, are moreover provided there, with which the workpieces 3 can be rinsed with de-ionised water after the cleaning and pretreatment. Alternatively, any other known type of cleaning such as acid cleaning, CO₂ dry ice, etc., may be used.

The blowing zone 9 includes a fan (not shown) with which water adhering to the surfaces of the workpieces 3 can for the most part be blown off after the rinsing in the wet chemical pretreatment zone 7, so that only individual water droplets still remain adhering to the surfaces.

The microwave zone 11 comprises a drying device identified overall by the reference numeral 33, for drying the individual water droplets still adhering to the surfaces of the workpieces 3 after the blowing procedure.

The drying device 33 comprises, as can be seen in FIGS. 1 and 2, four magnetron rings 35 arranged in succession in the direction of the conveying pathway 5. Each magnetron ring 35 comprises magnetrons 37 arranged roughly annularly in a plane perpendicular to the conveying direction 5 and directed inwardly onto the workpieces 3, as can be seen in FIG. 3. The magnetrons 37 are in each case secured in pairs to the two side walls 39 and to the ceiling 41 of the cabin 19 of the microwave zone 11. The magnetrons are arranged so that the microwaves can be transmitted to the interior of the cabin 19 of the microwave zone 11, i.e. onto the surfaces of the workpieces 3.

The magnetrons 37 are connected via power lines (not shown) to a switching cabinet 43 that is located next to the cabin 19 of the microwave zone 11, as shown at the top of FIG. 2. Power supply sources and control means for the magnetrons 37, which are not otherwise shown, are arranged in the switching cabinet 43.

By suitably operating the magnetrons 37 microwaves are generated by the latter having a wavelength that is optionally suitable in particular for heating water, the microwaves preferably being absorbed by the water droplets on the surfaces of the workpieces 3. The water droplets are heated by the microwaves and evaporated without leaving any residue, so that there is no entrainment of adhering water into the following cooling zone 13 and into the following, not shown, process zones.

In particular, due to the special arrangement of the magnetrons 37 and the choice of wavelength of the microwaves, the water droplets on the surfaces of the workpieces 3, as well as in depressions, for example pits, and in capillary regions, for example in perforations, are locally heated by the microwaves and are evaporated. The workpieces 3 themselves, the workpiece carriers 31 and also the skids 25 are in this connection scarcely heated, in other words only to less than 60° C., since the microwaves act substantially selectively on the water. In this way a rapid drying of the water adhering to the surfaces of the workpieces 3 as well as a very high energy efficiency can be achieved. Moreover, as a side effect the outgassing of the plastics material of the workpieces 3 can be improved due to the microwaves.

To cool the drying device 33, in particular the magnetrons 37, with cooling water, a cooling unit 45 is likewise arranged adjacent to the cabin 19 of the microwave zone 11, in FIG. 2 next to the switching cabinet 43, and is connected via cooling lines (not shown) to the drying device 33 and to cooling jackets (not shown) of the magnetrons 37.

For the wet chemical pretreatment of the surfaces of the workpieces 3 that are to be painted, these are first of all conveyed with the skids 25 and the workpiece carriers 31 through the conveying system 23 in batches at spaced intervals along the conveying pathway 5 into the wet chemical pretreatment zone 7. There the workpieces 3 are treated in the chemical baths containing the appropriate chemicals. The workpieces 3 are then rinsed with de-ionised water so that the surfaces are free from treatment chemicals.

The skids 25 and the workpiece carriers 31 together with the workpieces 3 are then transported batchwise in succession through the blowing zone 9, where most of the water adhering to the surfaces is blown off. Individual droplets of water however still adhere to the surfaces, in particular in depressions or capillary regions.

Following this the skids 25 together with the workpieces 3 are conveyed batchwise in succession further through the microwave zone 11, where the remaining water droplets on the surfaces of the workpieces 3 are now dried within 3 to 4 minutes by microwaves without leaving any residue, with the result that no entrainment of adhering water occurs, nor do the surfaces have to be post-treated on account of coating defects caused by water droplets.

Finally, the workpieces 3 are conveyed on the skids 25 batchwise in succession through the cooling zone 13, where they are cooled. The pretreatment is then complete.

The cooled workpieces 3 arranged on the skids 25 may then be fed directly via the conveying system 23 to a painting stage (not shown) downstream of the pretreatment apparatus 1, for the painting.

The workpieces 3 may be cleaned with the pretreatment apparatus I also simply with water without using chemicals.

The pretreatment apparatus I and the method are also not restricted to the pretreatment of workpieces 3 to be painted. Rather, the workpieces 3 can also be treated in other ways after the pretreatment, for example can also be bonded or welded.

The pretreatment apparatus 1 and the method may also be used to dry adhering residual water on already completely dry layers of paint, for example following a cleaning of the paint surface after sanding processes.

The pretreatment apparatus I may also comprise more than one drying device 33.

The workpieces 3 may, instead of being conveyed in batches, also be conveyed continuously or reversibly and also, during the transportation, in a rotating manner along the conveying pathway 5.

Instead of the conveying system 23 together with the skids 25, some other type of conveying technique may also be used.

The zones 7, 9, 11 and 13 also need not be arranged in succession in a straight line, but may also be arranged along a curve or may also be displaced horizontally or vertically.

Instead of the magnetrons 37 other microwave generators may also be employed, in particular microwave tubes, for example klystrons, or also microwave semiconductor components.

Also, fewer than six microwave generators may also be provided in an arrangement other than an annular arrangement. The annular arrangement of the microwave generators may also be inclined at an angle to the conveying pathway 5. More than or fewer than four annular arrangements may also be employed.

The workpieces 3 may be made of a material other than plastics, for example of metal, carbon fibres, glass, ceramics, or may be a composite material or a material matrix.

The conveying pathway 5 for the workpieces 3 may, instead of leading through a wet chemical pretreatment zone 7, also lead through several, also different, pretreatment zones.

Also, either only one blowing zone 9 or one cooling zone 13 may be provided. Furthermore, both types of zones may be dispensed with.

It should be emphasized that the above-described embodiments of the present invention, particularly, any “preferred” embodiments, are possible examples of implementations merely set forth for a clear understanding of the principles of the invention. Many variations and modifications may be made to the above-described embodiments of the invention without substantially departing from the spirit and principles of the invention. All such modifications are intended to be included herein within the scope of this disclosure and the present invention, and protected by the following claims.

1. An apparatus for the surface treatment of a workpiece including at least one pretreatment zone operating with a water-containing treatment liquid and at least with a drying device for drying water-containing treatment liquid adhering to the surface of the workpiece, the apparatus comprising:
a drying device including at least one microwave generator for drying the water-containing treatment liquid.

2. The apparatus according to claim 1, wherein the workpiece includes a plastic material or metal.

3. The apparatus according to claim 1, wherein the drying device comprises a plurality of microwave generators arranged in an annular manner around a conveying pathway of the workpiece.

4. The apparatus according to claim 3, wherein the conveying pathway upstream of the microwave zone leads through a blowing zone and/or, after the microwave zone, leads through a cooling zone.

5. A method for the surface treatment of a workpiece in which the surface of the workpiece is subjected to a treatment with a water-containing treatment liquid and treatment liquid adhering to the surface of the workpiece is dried, the method comprising the steps of:
utilizing a microwave to dry the water-containing treatment liquid.

6. The method according to claim 5, further comprising the steps of:
blowing off the treatment liquid from the surface of the workpiece before treatment liquid still adhering to the surface is dried with the microwave.

7. The method according to claim 6, further comprising:
cooling the workpiece after still adhering treatement liquid has been dried by the microwave.

8. The method according to claim 5, further comprising:
cooling the workpiece after still adhering treatement liquid has been dried by the microwave.
